(19) United States
(12) Patent Application Publication
(10) Pub. No.: US 2018/0270163 A1
(43) Pub. Date: Sep. 20, 2018

(54) PROFILE GUIDED LOAD OPTIMIZATION FOR BROWSERS

(71) Applicant: GOOGLE INC., Mountain View, CA (US)

(72) Inventors: Simon HATCH, San Francisco, CA (US); Oystein EFTEVAAG, Palo Alto, CA (US)

(73) Assignee: GOOGLE INC., Mountain View, CA (US)

(21) Appl. No.: 14/152,951

(22) Filed: Jan. 10, 2014

(51) Int. Cl. H04L 12/911

(52) U.S. Cl. CPC H04L 47/70

(57) ABSTRACT

Methods for profile guided load optimization for browsers are provided. In one aspect, a method includes receiving a request to load a web resource from a first server. The method also includes requesting a loading profile associated with the web resource. The method also includes receiving a response to the loading profile request. The method also includes requesting the web resource using parameter values based on the response to the loading profile request. Systems and machine-readable media are also provided.

### BACKGROUND

### Field

The present disclosure generally relates to the transmission of data over a network, and more particularly to the connection of a computing device with another computing device.

### Description of the Related Art

Web browsers typically employ scheduling algorithms in order to minimize time taken to download and display a web page to a user. Normally, page load time optimizations are adopted if the effects of the optimization have a positive net value over tens of thousands of web pages. However, a page load time optimization that may have a positive net value over tens of thousands of web pages may have a negative value for some webpages.

### SUMMARY

According to one embodiment of the present disclosure, a computer-implemented method for profile guided load optimization for browsers is provided. The method includes receiving a request to load a web resource from a first server. The method includes requesting a loading profile associated with the web resource. The method includes receiving a response to the loading profile request. The method includes requesting the web resource using parameter values based on the response to the loading profile request.

According to one embodiment of the present disclosure, a system for device pairing via a cloud server is provided. The system includes a memory storing executable instructions and a processor configured to execute the executable instructions stored in the memory to receive a request to load a web resource from a first server. The processor is further configured to request a loading profile associated with the web resource, wherein requesting the loading profile comprises determining whether the loading profile is available in a local cache. The processor is further configured to receive a response to the loading profile request, wherein receiving the response to the loading profile request comprises receiving the loading profile from the local cache. The processor is further configured to request the web resource using parameter values based on the response to the loading profile request.

According to one embodiment of the present disclosure, a computer-implemented method for profile guided load optimization for browsers is provided. The method includes receiving, from a client device, a request for a loading profile associated with a web resource. The method includes searching a database for the loading profile, the database storing one or more loading profiles for respective web servers. The method includes determining whether the loading profile is stored in the database. The method includes sending a response to the loading profile request based on the determination of whether the loading profile is stored in the database.

According to one embodiment of the present disclosure, a system for device pairing via a cloud server is provided. The system includes a memory storing executable instructions and a processor configured to execute the executable instructions stored in the memory to receive identification of a web resource and local device information combination. The processor is further configured to receive identification of one or more loading parameters used in loading the web resource with the local device information. The processor is further configured to determine a parameter value for each of the one or more loading parameters. The processor is further configured to create a loading profile for the web resource, wherein the loading profile comprises the parameter values for each of the one or more loading parameters. The processor is further configured to associate the loading profile with the web resource and local device information combination.

According to one embodiment of the present disclosure, a non-transitory machine-readable medium embodying instructions is provided. These instructions, when executed by a machine, allow the machine to perform a method. The method includes receiving, from a client device, a request for a loading profile associated with a web resource. The method also includes searching a database for the loading profile, the database storing one or more loading profiles for respective web servers. The method also includes determining whether the loading profile is stored in the database. The method also includes sending a response to the loading profile request based on the determination of whether the loading profile is stored in the database. The method also includes receiving identification of an unprofiled web resource. The method also includes receiving identification of one or more loading parameters used in loading the unprofiled web resource. The method also includes determining a parameter value for each of the one or more loading parameters. The method also includes creating a loading profile for the unprofiled web resource, wherein the loading profile comprises the parameter values for each of the one or more loading parameters. The method also includes associating the loading profile with the unprofiled web resource.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for profile guided load optimization for browsers.

FIG. 2 is a block diagram illustrating an example client and server from the architecture of FIG. 1 according to certain aspects of the disclosure.

FIG. 3A illustrates an example process for profile guided load optimization for browsers using the example client of FIG. 2.

FIG. 3B illustrates an example process for profile guided load optimization for browsers using the example client of FIG. 2.

FIG. 3C illustrates an example process for profile guided load optimization for browsers using the example client of FIG. 2.

FIG. 3D illustrates an example process for profile guided load optimization for browsers using the example client of FIG. 2.

FIG. 4 is a block diagram illustrating an example computer system with which some implementations of the subject technology can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Many current optimization strategies for web browsers are used because they have a net positive effect over tens of thousands of websites. However, the effect of the optimization on one particular website may be negative, even though the net effect over the tens of thousands of websites is positive. A preferred approach would be to customize optimization strategies for individual web resources, in order to achieve a positive effect over each of the websites, instead of merely a net positive effect.

The disclosed application provides for profile guided load optimization for browsers. The subject technology creates a loading profile for each web resource, so that the web resource is loaded depending on the characteristics of the web resource. In this way, loading may be tailored to the individual web resource, instead of using a general approach.

The loading profile contains a set of loading parameters that enables the browser to load the web resource faster than if default loading parameters were used. The subject technology creates the loading profile by loading the webpage using different values for each loading parameter. The loading parameter value that results in the fastest page load may be saved to the loading profile. The loading profile is stored on a loading profile server.

If a user enters in a request to a client device to access a web resource, the subject technology checks to see if a loading profile for the web resource is available. The subject technology may check the loading profile server, or a local cache of loading profiles. If the loading profile is located, then the subject technology uses the parameter values in the loading profile to load the web resource. After obtaining a loading profile from the loading profile server, it may be saved to the local loading profile cache.

In some aspects, new or updated loading profiles may be proactively pushed to the client device, through normal browser update mechanisms. In some aspects, a new or updated loading profile may be available from a server. The server may notify the client device that a new or updated loading profile is available to download. The client device may then download the new or updated loading profile from the server, onto the local loading profile cache. In some aspects, the client device periodically checks the server for new or updated loading profiles, and saves any new or updated loading profiles onto the local loading profile cache. After the client device has received a new or updated loading profile from the server, the client device is now able to access the new or updated loading profile from the local loading profile cache instead of requesting it from the loading profile server.

In some aspects, loading profiles may be included in the initial install files of the browser, and may be stored to the local loading profile cache. The client device is then able to access the loading profile from the local loading profile cache, instead of requesting it from the loading profile server.

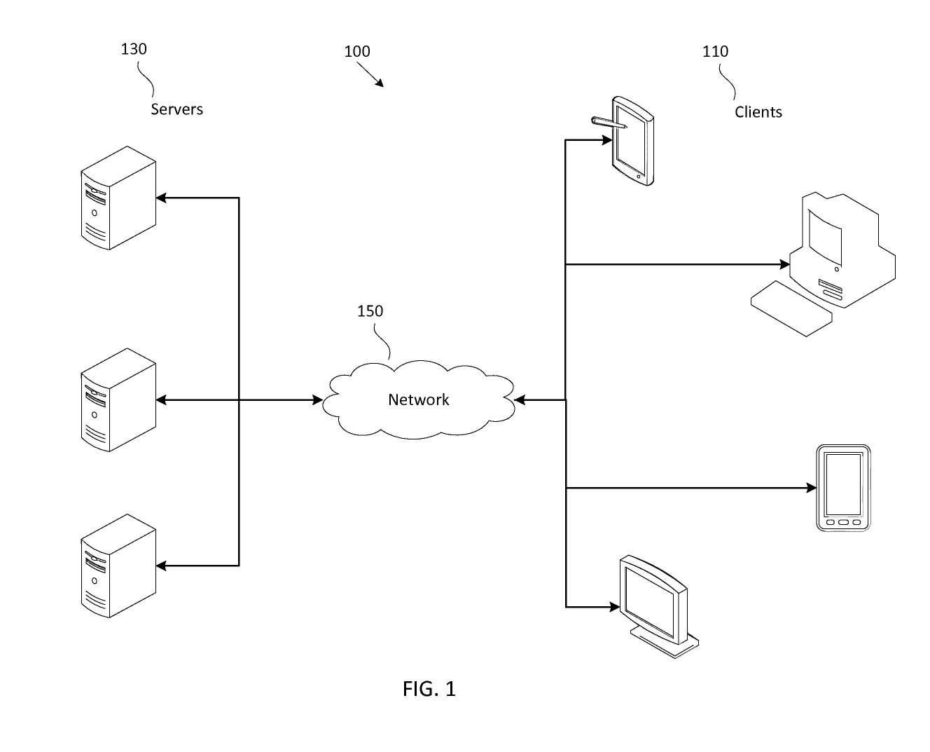

FIG. 1 illustrates an example architecture 100 for profile guided load optimization for browsers. The architecture 100 includes servers 130 and clients 110 connected over a network 150.

Each of the many clients 110 is configured to include and execute an application for providing content. The application can be, for example, a web browser, a video playing program, a document or text editing program, an image editing program, a video editing program, a gaming program, or any other program. The content can be, for example, a web page, a document, an image, a video, an audio file, a game, or other content. In order for the client 110 to provide the content, the client 110 may have to access a server 130 for a web resource. A web resource may also be, for example, a web page, a document, an image, a video, an audio file, a game, or other content.

The clients 110 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities for providing content. In some embodiments, a client 110 may be a proxy server or other intermediary, that makes connections and fetches resources on behalf of some other client.

The servers 130 can be any device having an appropriate processor, memory, and communications capability for hosting the content. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

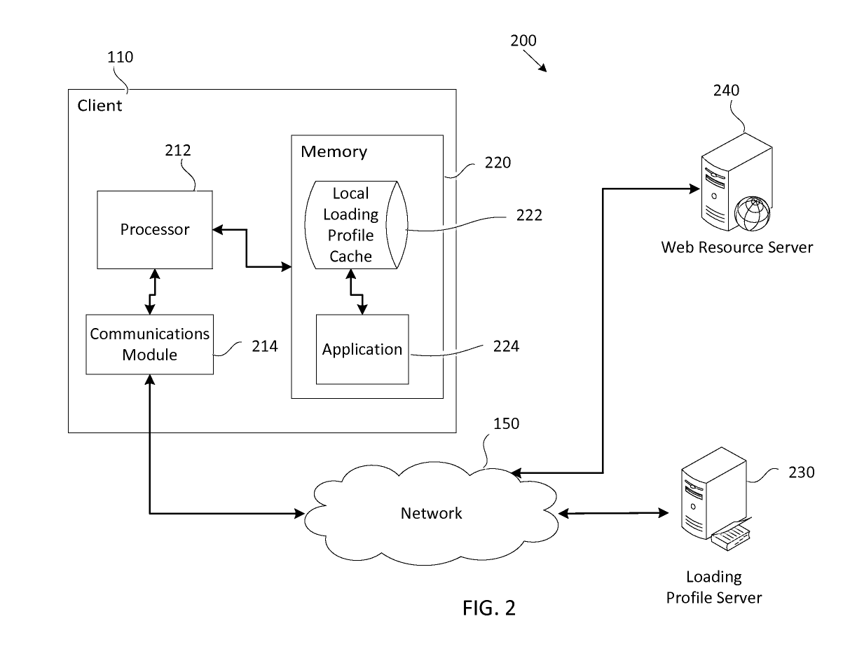

FIG. 2 is a block diagram 200 illustrating example client 110 and servers 230, 240 in the architecture 100 of FIG. 1 according to certain aspects of the disclosure. The client 110 and the servers 230, 240 are connected over the network 150.

The client 110 includes a processor 212, a communications module 214, a memory 220 that includes an application 224, and a local loading profile cache 222. The processor 212 of the client 110 is configured to execute instructions, such as instructions physically coded into the processor 212, instructions received from software (e.g., application 224) in memory 220, or a combination of both, for profile guided load optimization for browsers.

The communications module 214 is configured to interface with the network 150 to send and receive information, such as data, requests, responses, and commands to other devices on the network. The communications module 214 can be, for example, modems or Ethernet cards.

The application 224 can be a web browser, a document or text editing program, an image editing program, a video editing program, a gaming program, or any other program. By way of non-limiting example, the content as discussed herein will be a web page, although other content can be used with the disclosed system, such as a document, an image, a video, an audio file, a game, or other content. The local loading profile cache 222 stores loading profiles, which may be indexed by their respective associated web resources.

The web resource server 240 is a server that is accessible over the network 150 and stores web resources. A web resource may be, for example, a web page, a document, an image, a video, an audio file, a game, or other content. A web resource may be a website with multiple webpages. A webpage may contain other web resources, such as images, video, or audio.

The loading profile server 230 is a server that is accessible over the network 150 and stores loading profiles, which may be indexed by their respective associated web resources. The loading profile contains a set of loading parameters. In some aspects, the loading profile contains the loading parameters that result in the fastest loading of the web resource. Examples of loading parameters may include, but are not limited to: the number and order in which to handle simultaneous downloads, knowledge about which domains and subdomains to preresolve and preconnect, the order in which to resolve and connect to these domains and subdomains, meta-data about child resources for predictive purposes, and the order in which to present resources on the webpage. In some aspects, the loading profile may expire.

In some aspects, the loading profile server 230 creates the loading profiles, updates the loading profiles, stores the loading profiles, and provides the loading profiles to the clients 110. In some aspects, the loading profile server 230 is populated using loading profiles created by another server that creates and updates loading profiles and the loading profile server 230 stores and provides loading profiles to clients 110.

In some aspects, loading parameter values are determined by loading the web resource with each potential loading parameter value. In some aspects, the loading parameter value that results in the fastest loading of the web resource is the value that is saved to the loading profile. Multiple possible values may exist as possible loading parameter values. In order to determine the value to save in the loading profile, each possible value may be tested, and the results may be analyzed to determine which possible loading parameter value is saved to the loading profile.

For example, a webpage example.com may contain two domains to resolve and connect to: subdomain1.example.com, and subdomain2.example.com. One of the loading parameters for example.com may be the order in which the two domains (subdomain1.example.com and subdomain2.example.com) should be resolved and connected to. In order to determine the order that results in the fastest loading of example.com, each ordering combination of the two domains (subdomain1.example.com and subdomain2.example.com) are tested. For example, resolving and connecting to subdomain1.example.com before resolving and connecting to subdomain2.example.com may take 0.523 ms. Resolving and connecting to subdomain2.example.com before resolving and connecting to subdomain1.example.com may take 0.497 ms. Because resolving and connecting to subdomain2.example.com before resolving and connecting to subdomain1.example.com results in a faster loading of example.com, the value “subdomain2.example.com; subdomain1.example.com” may be saved in the loading profile for example.com, under the parameter value of “order to resolve and connect to domains.”

In some aspects, loading profiles may become outdated if the web resource changes. In the above example, if example.com no longer linked to subdomain1.example.com, or if a third domain, subdomain3.example.com were added to example.com, then the value of “subdomain2.example.com; subdomain1.example.com” for the parameter value of “order to resolve and connect to domains” becomes outdated. In some aspects, if a loading profile becomes outdated, the entire loading profile is determined again. In some aspects, if a loading profile becomes outdated, only the parameter values for the outdated loading parameters are determined again. In some aspects, a time may be associated with a loading profile, indicating the time the loading profile expires.

In some aspects, upon the expiration of a loading profile, an updated loading profile is determined and stored on the loading profile server 230. In some aspects, an updated loading profile is determined by performing the same steps as performed to determine the expired loading profile. In some aspects, if only some loading parameters are expired, then only the parameter values for those loading profiles are determined again. In some aspects, if the loading profile stored in the local loading profile cache 222 is expired, the client 110 requests an updated loading profile from the loading profile server 230.

In some aspects, new or updated loading profiles may be proactively pushed to the client 110, through normal application 224 (e.g., web browser) update mechanisms. In some aspects, loading profiles may be included in the initial install files of the application 224 (e.g., web browser), and may be stored to the local loading profile cache 222.

In some aspects, the loading profile for a web resource may also be associated with local device information. In some aspects, local device information may comprise information regarding the client device type. For example, cell phone, smartphone, tablet, desktop computer, and laptop computer. In some aspects, local device information may comprise information regarding the client device specifications. For example, single processor, dual processor, quad processor, WiFi connection, 3G connection, 4G connection, LTE connection, HSPA connection, and memory capacity. In some aspects, local device information may comprise information regarding the environment in which the device operates. For example, connection quality, location information, and types of connections available.

In some aspects, when the parameter values are determined for each of the one or more loading parameters, local device information may be used. For example, there may be more than one loading profile for a website (e.g., example.com). There may be a first loading profile for example.com when viewed on a smartphone, a second loading profile when viewed on a laptop, a third loading profile when a WiFi connection is used, a fourth loading profile when the device is located in the United States, a fifth loading profile when viewed on a smartphone with dual processors, using 4G connection.

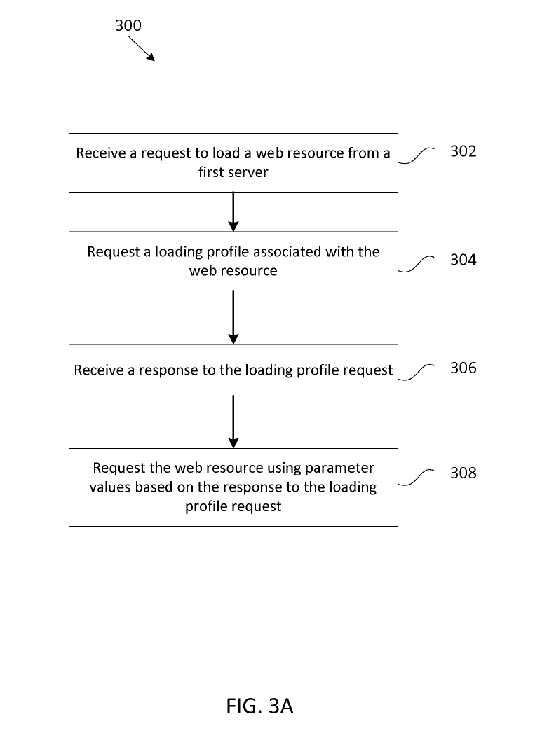

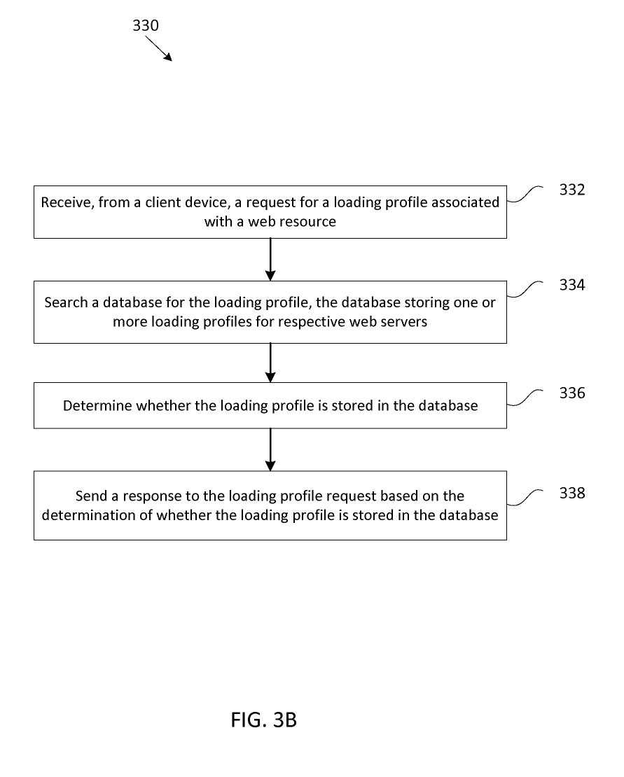

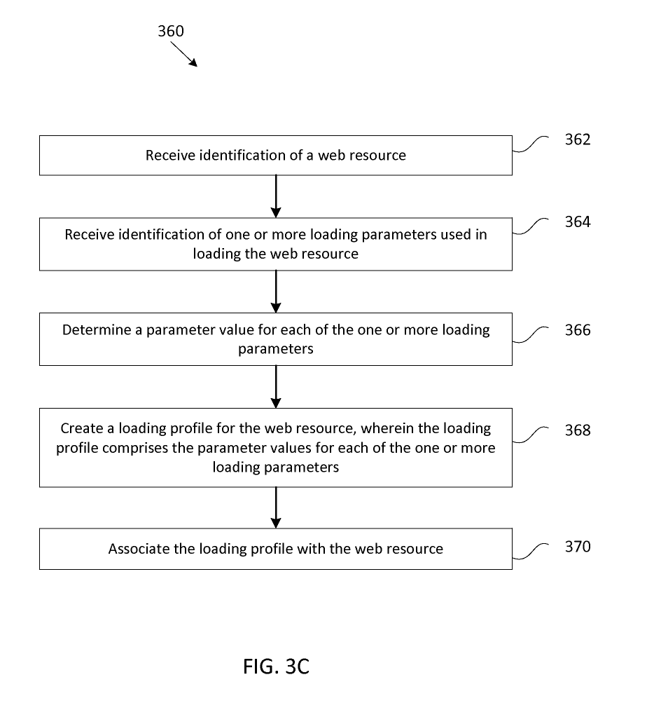

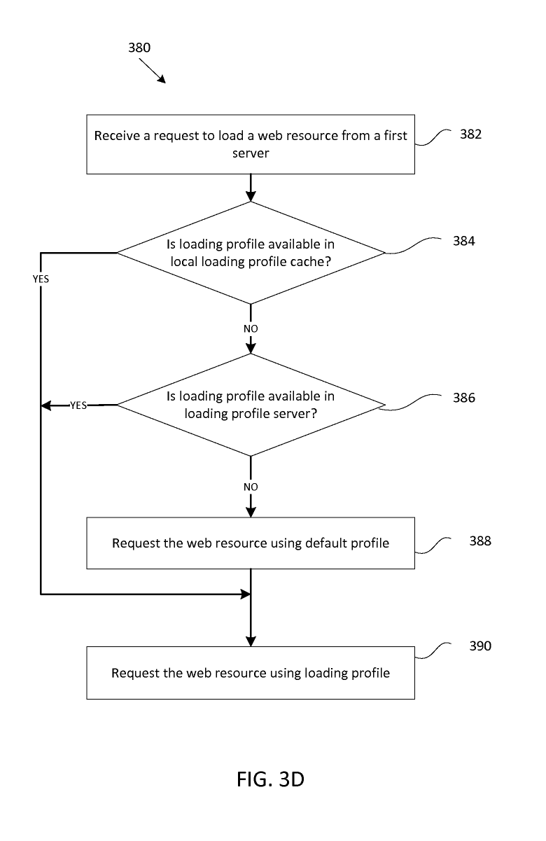

FIG. 3A illustrates an example process 300, from the perspective of the client 110, for profile guided load optimization for browsers using the example client 110, network 150, and servers 230, 240 of FIG. 2. While FIG. 3A is described with reference to FIG. 2, it should be noted that the process blocks of FIG. 3A may be performed by other systems.

The process 300 begins at block 302, in which a request is received to load a web resource from a first server. In some aspects, the first server is a web resource server 240.

The process 300 proceeds to block 304, in which a loading profile associated with the web resource is requested. In some aspects, the loading profile is requested from the local loading profile cache 222. In some aspects, the loading profile is requested from the loading profile server 230.

In some aspects, when the loading profile is requested from the local loading profile cache 222, a determination is made whether the loading profile available in the local loading profile cache 222 has expired. When it is determined that the loading profile available in the local loading profile cache 222 has expired, the loading profile in the local loading profile cache 222 is updated by requesting an updated loading profile from the loading profile server 230. In some aspects, the loading profile server 230 may update expired loading profiles by re-determining parameter values for all loading parameters. In some aspects, the loading profile server 230 may update expired loading profiles by re-determining parameter values for the expired loading parameters.

In some aspects, new or updated loading profiles may be proactively pushed to the client 110, through normal application 224 (e.g., web browser) update mechanisms. In some aspects, loading profiles may be included in the initial install files of the application 224 (e.g., web browser), and may be stored to the local loading profile cache 222.

The process 300 proceeds to block 306, in which a response to the loading profile request is received. When the loading profile is available, either from the local loading profile cache 222 or the loading profile server 230, the response to the loading profile request will contain the loading profile. When the loading profile is not available, either from the local loading profile cache 222 or the loading profile server 230, the response to the loading profile request will comprise an indication that no loading profile associated with the web resource is available. In some aspects, when no loading profile associated with the web resource is available, a default loading profile is used.

The process 300 proceeds to block 308, in which the web resource is requested from the web resource server 240 using parameter values based on the response to the loading profile request. As discussed previously, depending on the availability of the loading profile, either the loading profile corresponding to the web resource or the default loading profile will be used by the client 110 in loading the web resource.

With further reference to FIG. 3A, an example will now be described using the example process 300 of FIG. 3A, a client 110 that is a smartphone, and a web resource that is a webpage example.com.

The process 300 begins at block 302, in which a request is received by the smartphone 110 to load example.com from a first server. In some aspects, the first server is a web resource server 240.

The process 300 proceeds to block 304, in which a loading profile associated with example.com is requested. In some aspects, the loading profile is requested from the local loading profile cache 222. In some aspects, the loading profile is requested from the loading profile server 230.

The process 300 proceeds to block 306, in which a response to the loading profile request for example.com is received. When the loading profile is available, either from the local loading profile cache 222 or the loading profile server 230, the response to the loading profile request for example.com will contain the loading profile for example.com. When the loading profile is not available, either from the local loading profile cache 222 or the loading profile server 230, the response to the loading profile request will comprise an indication that no loading profile associated with the web resource is available. In some aspects, when no loading profile associated with the web resource is available, a default loading profile is used. In this example, the loading profile for example.com is received as the response.

The process 300 proceeds to block 308, in which example.com is requested from the web resource server 240 using parameter values based on the loading profile for example.com.

FIG. 3B illustrates an example process 302, from the perspective of the loading profile server 230, for profile guided load optimization for browsers using the example client 110, network 150, and servers 230, 240 of FIG. 2. While FIG. 3B is described with reference to FIG. 2, it should be noted that the process blocks of FIG. 3B may be performed by other systems.

The process 330 begins at block 332, in which a request is received from a client 110 for a loading profile associated with a web resource. In some aspects, this request may be received by a server (e.g., loading profile server 230). In some aspects, this request may be received by a local source (e.g., local loading profile cache 222 within memory 220).

The process 330 proceeds to block 334, in which a database is searched for the loading profile, the database storing one or more loading profiles for respective web servers. In some aspects, the database may be within the loading profile server 230. In some aspects, the database may be the local loading profile cache 222.

The process 330 proceeds to block 336, in which it is determined whether the loading profile is stored in the database. In some aspects, the loading profile is indexed in the database according to the associated web resource. In some aspects, the index is a table.

The process 330 proceeds to block 338, in which a response is sent based on the determination of whether the loading profile is stored in the database. In some aspects, when the loading profile is stored in the database, the response comprises the loading profile. In some aspects, when the loading profile is not stored in the database, the response comprises an indication that no loading profile is associated with the web resource. In some aspects, the indication is a message. In some aspects, the indication is an empty loading profile.

In some aspects, the loading profile server 230 creates the loading profiles, updates the loading profiles, stores the loading profiles, and provides the loading profiles to the clients 110. In some aspects, the loading profile server 230 is populated using loading profiles created by another server that creates and updates loading profiles and the loading profile server 230 stores and provides loading profiles to clients 110.

With further reference to FIG. 3B, an example will now be described using the example client 110, network 150, and servers 230, 240 of FIG. 2.

The process 330 begins at block 332, in which a request is received from a smartphone 110 for a loading profile associated with example.com. In some aspects, this request may be received by a server (e.g., loading profile server 230). In some aspects, this request may be received by a local source (e.g., local loading profile cache 222 within memory 220).

The process 330 proceeds to block 334, in which a database is searched for the loading profile associated with example.com. In some aspects, the database may be within the loading profile server 230. In some aspects, the database may be the local loading profile cache 222.

The process 330 proceeds to block 336, in which it is determined whether the loading profile associated with example.com is stored in the database. In some aspects, the loading profile is indexed in the database according to the associated web resource. In some aspects, the index is a table. In this example, the loading profile associated with example.com is stored in the database.

The process 330 proceeds to block 338, in which a response is sent based on the determination of whether the loading profile associated with example.com is stored in the database. In this example, because the loading profile associated with example.com is stored in the database, the response sent is the loading profile associated with example.com.

FIG. 3C illustrates an example process 360, from the perspective of the loading profile server 230, for profile guided load optimization for browsers using the example client 110, network 150, and servers 230, 240 of FIG. 2. While FIG. 3C is described with reference to FIG. 2, it should be noted that the process blocks of FIG. 3C may be performed by other systems.

The process 360 begins at block 362, in which identification of a web resource is received.

The process 360 proceeds to block 364, in which identification of one or more loading parameters used in loading the web resource is received. The loading parameters indicate settings to the browser requesting the web resource. Examples of loading parameters are: the number and order in which to handle simultaneous downloads, knowledge about which domains and subdomains to preresolve and preconnect, the order in which to resolve and connect to these domains and subdomains, meta-data about child resources for predictive purposes, and the order in which to present resources on the webpage.

The process 360 proceeds to block 366, in which a parameter value for each of the one or more loading parameters is determined. In some aspects, a list of parameter values are provided and each parameter value is tested individually to determine its effect on the loading of the web resource. In some aspects, the web resource is analyzed to determine parameter values. For example, a web resource that is a webpage may be analyzed to determine how many simultaneous downloads to perform, or the metadata associated with the webpage. In some aspects, the parameter value that results in the fastest loading of the web resource is determined. In some aspects, the parameter value that results in the most reliable loading of the web resource is determined. In some aspects, the parameter value that results in the loading of the web resource using the least amount of resources is determined.

In some aspects, the parameter values for each of the one or more loading parameters are determined individually. In some aspects, the parameter values for each of the one or more loading parameters are determined in combination with one or more other loading parameters. For example, the order of download requests may be determined in combination with the order of domain name preresolution requests.

In some aspects, client device information may be taken into account. The parameter values for a particular loading parameter may be different when the web resource is loaded on a smartphone, as opposed to a tablet, as opposed to a laptop. In some aspects, a number of different devices may be used when performing the analysis, in order to determine parameter values tailored to those different devices. In some aspects, the server that is performing the analysis may roughly approximate the characteristics of a number of different devices when performing the analysis, in order to determine parameter values tailored to those different devices.

The process 360 proceeds to block 368, in which a loading profile is created for the web resource, wherein the loading profile comprises the parameter values for each of the one or more loading parameters.

The process 360 proceeds to block 370, in which the loading profile is associated with the web resource.

FIG. 3C sets forth an example process 360 for profile guided load optimization for browsers using the example client 110, network 150, and servers 230, 240 of FIG. 2. An example will now be described using the example process 360 of FIG. 3C, a client 110 that is a smartphone, and a web resource that is a webpage example.com, and loading parameters of number and order of simultaneous downloads.

The process 360 begins at block 362, in which identification of a web resource, example.com, is received.

The process 360 proceeds to block 364, in which identification of loading parameters of number and order of simultaneous downloads is received. The loading parameters indicate settings to the browser requesting the web resource.

The process 360 proceeds to block 366, in which a parameter value for number and order of simultaneous downloads is determined. The number of simultaneous downloads may be determined by analysis of example.com. The order in which to perform the simultaneous downloads may be determined by attempting each sequence of downloads. In this example, it is determined that there are three simultaneous downloads, A, B, and C, and they should be performed in the order of: B, A, C.

In some aspects, device information may be taken into account. In this example, the parameter value for number and order of simultaneous downloads for example.com may be determined for a number of different devices (e.g., laptop, smartphone, tablet). The order in which to perform the simultaneous downloads of A, B, and C may be different for each device. For example, the order in which the simultaneous downloads should be performed on a laptop may be B, A, C. The order in which the simultaneous downloads should be performed on a smartphone may be A, B, C. The order in which the simultaneous downloads should be performed on a tablet may be A, C, B.

The process 360 proceeds to block 368, in which a loading profile is created, wherein the loading profile comprises three simultaneous downloads and downloading them in the order of: B, A, C.

The process 360 proceeds to block 370, in which the loading profile is associated with example.com.

FIG. 3D illustrates an example process 380, from the perspective of the client 110, for profile guided load optimization for browsers using the example client 110, network 150, and servers 230, 240 of FIG. 2. While FIG. 3D is described with reference to FIG. 2, it should be noted that the process blocks of FIG. 3D may be performed by other systems.

The process 380 begins at block 382, in which a request to load a web resource from a first server is received.

The process 380 proceeds to decision block 384, in which the local loading profile cache 222 is checked to see if the loading profile is available. If the loading profile is available, the process 380 proceeds to block 390, in which the web resource is requested using the loading profile. If the loading profile is unavailable, the process 380 proceeds to decision block 386.

In decision block 386, the loading profile server 230 is checked to see if the loading profile is available. If the loading profile is available, the process 380 proceeds to block 390, in which the web resource is requested using the loading profile. If the loading profile is unavailable, the process 380 proceeds to block 388.

In block 388, the web resource is requested using a default profile, since the loading profile is not available from the local loading profile cache 222 or the loading profile server 230.

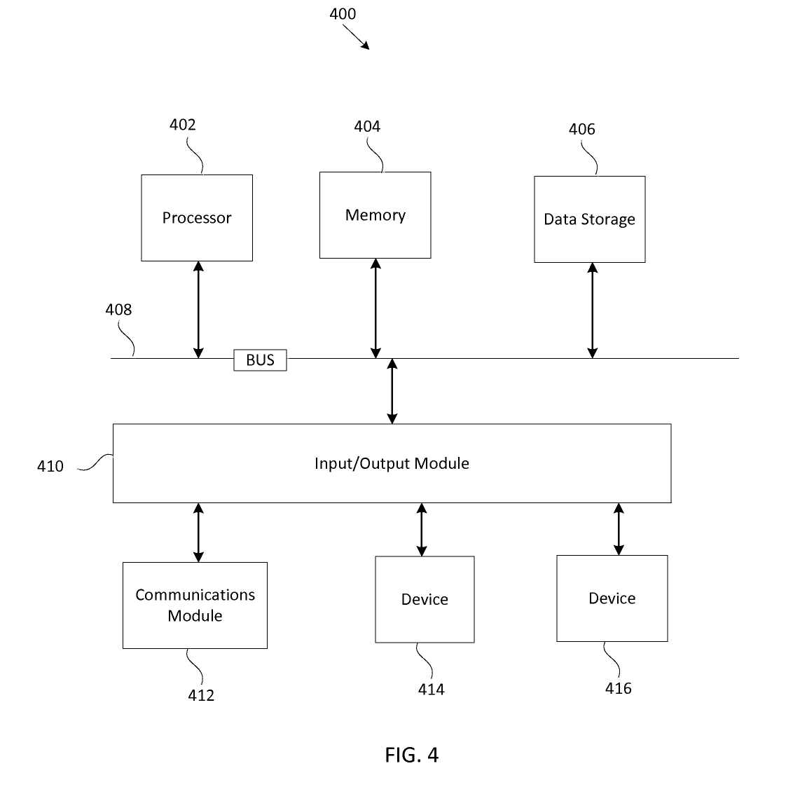

FIG. 4 is a block diagram illustrating an example computer system 400 with which some implementations of the subject technology can be implemented. In certain aspects, the computer system 400 may be implemented using hardware or a combination of software and hardware, either in a dedicated server, or integrated into another entity, or distributed across multiple entities.

Computer system 400 (e.g., clients 110 and servers 130) includes a bus 408 or other communication mechanism for communicating information, and a processor 402 (e.g., processor 212) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Example input/output modules 410 include data ports such as USB ports. The input/output module 410 is configured to connect to a communications module 412. Example communications modules 412 (e.g., communications module 214) include networking interface cards, such as Ethernet cards and modems. In certain aspects, the input/output module 410 is configured to connect to a plurality of devices, such as an input device 414 and/or an output device 416. Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 416 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 402 for execution. Such a medium may take many forms, including, but not limited to, non-volatile media, volatile media, and transmission media. Non-volatile media include, for example, optical disks, magnetic disks, or flash memory, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method comprising:
receiving at a client device, from an application executing on the client device, a request for a web resource;
determining, in response to the request for the web resource, whether a loading profile associated with the web resource is available in a local cache stored on the client device, wherein the loading profile includes information for loading the web resource, and the loading profile is different than the web resource;
sending by the client device, in response to determining that the loading profile is not available in the local cache of the client device, a request, to a server, for the loading profile associated with the web resource, the request for the loading profile includes client device information;
receiving, on the client device, a response from the server to the request for the loading profile, the response including a set of loading parameters associated with the client device based on the client device information, the set of loading parameters indicating settings to the application on the client device for how to load the web resource at the client device, wherein the set of loading parameters further include a loading parameter associated with the client device for a number of simultaneous downloads and an order to handle the simultaneous downloads; and
providing, for transmission, a request for the web resource using one or more parameter values from the set of loading parameters associated with the client device.

2. The method of claim 1, wherein the response to the request for the loading profile comprises the loading profile, and wherein the loading profile comprises the set of loading parameters.

3. The method of claim 1, wherein the response to the request for the loading profile comprises an indication that no loading profile is associated with the web resource, and wherein the one or more parameter values are included within a default profile associated with the server.

4. The method of claim 1, wherein providing the request for the loading profile comprises requesting the loading profile from the server, and
wherein receiving the response to the loading profile request comprises receiving the response from the server.

5. The method of claim 1, further comprising:
receiving, in response to the loading profile being available in the local cache, the response to the request for the loading profile from the local cache.

6. The method of claim 5, further comprising:
determining whether the loading profile present in the local cache has expired; and
when it is determined that the loading profile present in the local cache has expired, updating the loading profile by requesting the loading profile from the server.

7. The method of claim 1, wherein the web resource is at least one of: a webpage, a video, a document, an image, an audio file, or a game.

8. (canceled)

9. The method of claim 1, wherein the local device information is at least one of: a device type, a device specification, a connection type, location information.

10. A system comprising:
a memory storing executable instructions; and
a processor configured to execute the executable instructions stored in the memory to:
receive at a client device, from an application executing on the client device, a request for a web resource;
determine, by the client device, whether a loading profile associated with the web resource is available in a local cache of the client device, wherein the loading profile is associated with information for loading the web resource, and the loading profile is different than the web resource;
send, in response to determining that the loading profile is available in the local cache of the client device, a request for the loading profile associated with the web resource to the local cache, the request for the loading profile includes client device information;
receive a response to the request for the loading profile, the response to the request for the loading profile being received from the local cache, the response including a set of loading parameters associated with the client device based on the client device information, the set of loading parameters indicating settings to the application for how to load the web resource at the client device, wherein the set of loading parameters further include a loading parameter associated with the client for a number of simultaneous downloads and an order to handle the simultaneous downloads; and
provide, for transmission, a request for the web resource using one or more parameter values from the set of loading parameters.

11. The system of claim 10, wherein the response to the request for the loading profile comprises the loading profile, and wherein the loading profile comprises the set of loading parameters.

12. The system of claim 10, wherein the response to the request for the loading profile comprises an indication that no loading profile is associated with the web resource, and wherein the one or more parameter values are included within a default profile associated with a server.

13. The system of claim 10, wherein the processor is further configured to:
determine whether the loading profile present in the local cache has expired; and
when it is determined that the loading profile present in the local cache has expired, updating the loading profile by requesting the loading profile from a server.

14. A computer-implemented method comprising:
receiving, from a client device, a request for a loading profile associated with a web resource, the request for the loading profile includes client device information, wherein the request was sent by the client device in response to the client device receiving a request for the web resource from an application executing on the client device and determining, by the client device, that the loading profile associated with the web resource is not available in a local cache of the client device;
searching a database for the loading profile, the database storing one or more loading profiles for respective web resources;
determining that the loading profile is stored in the database; and
sending, to the client device, a response to the request for the loading profile based on the determination that the loading profile is stored in the database, the response including a set of loading parameters associated with the client device based on the client device information, the set of loading parameters indicating settings to the application of the client device requesting the web resource for how to load the web resource at the client device, wherein the set of loading parameters further include a loading parameter associated with the client device for a number of simultaneous downloads and an order to handle the simultaneous downloads.

15. The method of claim 14, further comprising:
receiving identification of an unprofiled web resource;
receiving identification of one or more loading parameters used in loading the unprofiled web resource;
determining parameter values for each of the one or more loading parameters;
creating a new loading profile for the unprofiled web resource, wherein the new loading profile comprises the parameter values for each of the one or more loading parameters; and
associating the new loading profile with the unprofiled web resource.

16. The method of claim 15, wherein a particular parameter value of the determined parameter values is a value that results in a first page loading time that is smaller than a second page loading time associated with default loading parameters.

17. The method of claim 15, wherein the parameter values of each of the one or more loading parameters are determined individually.

18. The method of claim 15, wherein the parameter values of each of the one or more loading parameters are determined in combination with one or more other loading parameters.

19. The method of claim 15, further comprising:
receiving identification of an expired loading profile;
receiving identification of one or more expired loading parameters of the expired loading profile;
determining an updated parameter value for each of the one or more expired loading parameters; and
updating the expired loading profile with updated parameter values for each of the one or more expired loading parameters.

20. The method of claim 14, wherein the web resource is at least one of: a webpage, a video, a document, an image, an audio file, or a game.

21. A system comprising:
a memory storing executable instructions; and
a processor configured to execute the executable instructions stored in the memory to:
receive identification of a web resource and local device information combination, wherein the identification of the web resource is received in a request from a client device in response to the client device determining that a loading profile associated with the web resource is not available in a local cache of the client device;
receive identification of one or more loading parameters used in loading the web resource with the local device information, the one or more loading parameters associated with the local client device, the one or more loading parameters indicating settings to an application of the client device requesting the web resource for how to load the web resource at the client device, wherein the application executes on the client device, the client device sends a request for information for loading the web resource, the request for information is sent in response to a request from the application for the web resource;
determine parameter values for each of the one or more loading parameters associated with the local client device, wherein the one or more loading parameters further include a loading parameter associated with the local client device for a number of simultaneous downloads and an order to handle the simultaneous downloads;
create a loading profile for the web resource, wherein the loading profile comprises the parameter values for each of the one or more loading parameters; and
associate the loading profile with the web resource and local device information combination.

22. The system of claim 21, wherein the parameter values of each of the one or more loading parameters are determined individually.

23. The system of claim 21, wherein the parameter values of each of the one or more loading parameters are determined in combination with one or more other loading parameters.

24. The system of claim 21, wherein the processor is further configured to:
receive identification of an expired loading profile;
receive identification of one or more expired loading parameters of the expired loading profile;
determine an updated parameter value for each of the one or more expired loading parameters; and
update the expired loading profile with updated parameter values for each of the one or more expired loading parameters.

25. A non-transitory machine-readable medium embodying instructions that, when executed by a machine, allow the machine to perform a method comprising:
receiving, from a client device, a request for a loading profile associated with a web resource, wherein the request was sent by the client device in response to the client device receiving a request for the web resource from an application executing on the client device and determining, by the client device, that the loading profile associated with the web resource is not available in a local cache of the client device;
searching a database for the loading profile, the database storing one or more loading profiles for respective web resources;
determining whether the loading profile is stored in the database;
sending a response to the request for the loading profile based on the determination of whether the loading profile is stored in the database, the request for the loading profile includes client device information;
receiving identification of an unprofiled web resource;
receiving identification of one or more loading parameters used in loading the unprofiled web resource, the one or more loading parameters associated with the client device based on the client device information, the one or more loading parameters indicating settings to an application of the client device requesting the unprofiled web resource for how to load the unprofiled web resource at the client device;
determining parameter values for each of the one or more loading parameters, wherein the one or more loading parameters further include a loading parameter associated with the client device for a number of simultaneous downloads and an order to handle the simultaneous downloads;
creating a new loading profile for the unprofiled web resource, wherein the new loading profile comprises the parameter values for each of the one or more loading parameters; and
associating the new loading profile with the unprofiled web resource.

26. The computer-implemented method of claim 1, wherein the response includes a plurality of sets of loading parameters that respectively correspond to different page load times for loading the web resource based on a type of the client device.

27. The computer-implemented method of claim 1, wherein the loading parameter for the number of simultaneous downloads is determined by an analysis of the web resource.

28. The computer-implemented method of claim 1, wherein the loading parameter for the order to handle the simultaneous downloads is determined by attempting each sequence of downloads.

29. The computer-implemented method of claim 1, wherein the loading parameter for the number of simultaneous downloads and the order to handle the simultaneous downloads is further based on device information, the device information indicating a type of device.

30. (canceled)

31. The computer-implemented method of claim 1, wherein the loading profile associated with the web resource is stored remotely on a loading profile server and the web resource is stored at a second server different than the loading profile server.
